(19) United States
(12) Patent Application Publication
(10) Pub. No.: US 2014/0117174 A1
(43) Pub. Date: May 1, 2014

(54) ELECTRONIC DEVICE SUPPORT

(71) Applicants: TSAI-JEN TAN, LUZHU TOWNSHIP (TW); WEN-PIN YANG, NEW TAIPEI CITY (TW)

(72) Inventors: TSAI-JEN TAN, LUZHU TOWNSHIP (TW); WEN-PIN YANG, NEW TAIPEI CITY (TW)

(21) Appl. No.: 13/663,587

(22) Filed: Oct. 30, 2012

(51) Int. Cl. F16M 11/22

(52) U.S. Cl. 248/176.1

(57) ABSTRACT

An electronic device support for installing a clamping means to clamp and hold an electronic device is introduced. The electronic device support includes a rod and two bases. The rod is in an arc shape; each base has a connecting portion; both ends of the rod are installed at the connecting portions respectively. In the electronic device support, the arc shape rod is combined with the bases, so that the electronic device can be raised and fixed appropriately by the electronic device support to achieve the effects of facilitating a user who lies in bed to use the electronic device without holding the electronic device as well as facilitating the user to leave the bed.

### FIELD OF THE INVENTION

The present invention relates to an electronic device support, in particular to the electronic device support used on a bed.

### BACKGROUND

When a user lying on bed or a bedridden patient uses an electronic device (such as a tablet PC or a Smartphone) on a bed, the user or patient has to hold the electronic device by a hand and operate the electronic device by the other hand to obtain the viewing and operating functions. However, it is very difficult for users or patients to hold the electronic device for a long time, and the inconvenience of holding the electronic device even makes it more difficult for the users or patients, if not impossible, to select a comfortable lying position such as the back-lying position or side-lying position in order to view the electronic device.

It is a main subject for the present invention to overcome the difficulty and inconvenience of prior art by providing an electronic device support to users who use an electronic device while lying in bed.

### SUMMARY

Therefore, it is a primary objective of the present invention to provide an electronic device support, in hope of achieving the effect of facilitating users who lie in bed to use an electronic device without the need of holding the electronic device.

To achieve the aforementioned objective, the present invention provides an electronic device support is provided for installing a clamping means, and the clamping means is provided for clamping and holding an electronic device. The electronic device support comprises a rod and two bases. The rod is in an arc shape; and each base has a connecting portion, and both ends of the rod are installed at the connecting portions respectively. Wherein, each of the connecting portions is situated at a peripheral edge of each of the bases, and the bases are extended towards a first direction and a second direction, and the first direction and the second direction are perpendicular to the rod, and the first direction and the second direction are opposite to each other.

In a preferred embodiment, the rod and the bases are coupled by an assembling method.

In a preferred embodiment, each of the connecting portions has a notch, and both ends of the rod are latched into the notches respectively.

In a preferred embodiment, the curvature of the rod is equal to 180 degrees.

In a preferred embodiment, the cross-sectional shape of the rod is in a geometric shape such as a circular shape, an elliptical shape, a rectangular shape or a triangular shape.

In the electronic device support of the present invention, the arc shaped rod and the bases are combined to form the electronic device support to raise and fix an electronic device appropriately, so as to achieve the effects of facilitating a user who lies in bed and uses the electronic device without holding the electronic device as well as facilitating the user to leave the bed.

### BRIEF DESCRIPTION OF THE DRAWINGS

FIG. 1 is a perspective view of an electronic device support in accordance with a preferred embodiment of the present invention;

FIG. 2 is an exploded view of an electronic device support in accordance with a preferred embodiment of the present invention;

FIG. 3 is an exploded view of an electronic device support in accordance with another preferred embodiment of the present invention;

FIG. 4 is a first schematic view of a using status of an electronic device support in accordance with a preferred embodiment of the present invention;

FIG. 5 is a second schematic view of a using status of an electronic device support in accordance with a preferred embodiment of the present invention; and

FIG. 6 is a third schematic view of a using status of an electronic device support in accordance with a preferred embodiment of the present invention.

### DETAILED DESCRIPTION

The objects, characteristics and effects of the present invention will become apparent with the detailed description of the preferred embodiments and the illustration of related drawings as follows.

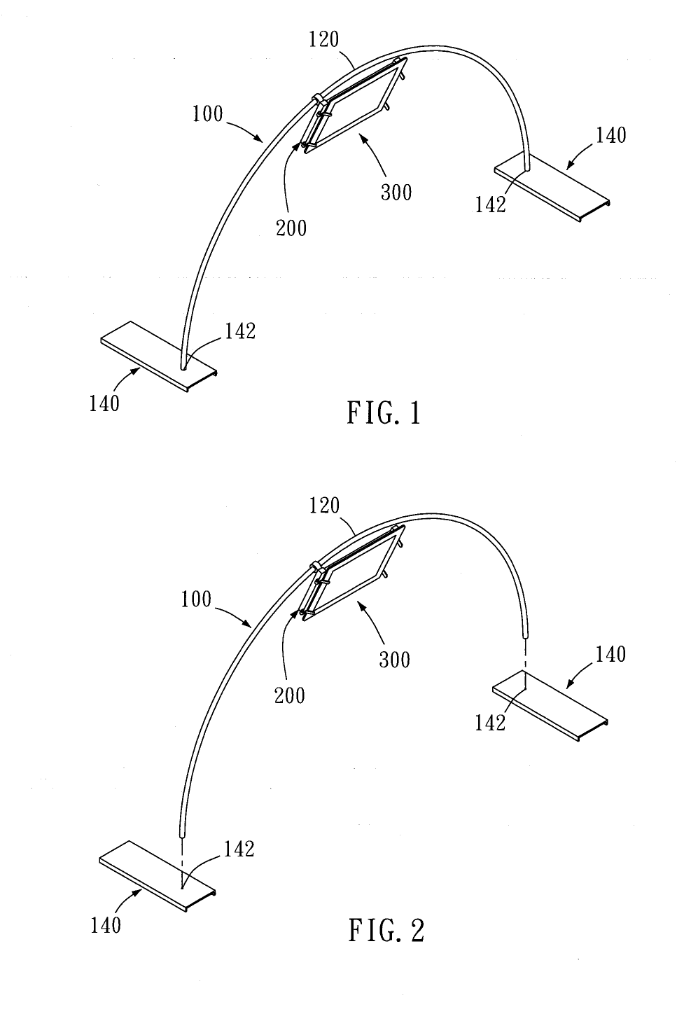

With reference to FIGS. 1 to 3 for a perspective view and an exploded view of an electronic device support in accordance with a preferred embodiment of the present invention and an exploded view of an electronic device support in accordance with another preferred embodiment of the present invention respectively, the electronic device support 100 as shown in FIGS. 1 and 2 comprises a rod 120 and two bases 140. Wherein, the electronic device support 100 is provided for installing a clamping means 200, and the clamping means 200 is provided for clamping and holding an electronic device 300.

The rod 120 is in an arc shape, and each of the bases 140 has a connecting portion 142, and both ends of the rod 120 are installed at the connecting portions 142 respectively, and the bases 140 are provided for supporting the rod 120, wherein each of the connecting portions 142 is disposed near a peripheral edge of each of the bases 140, and the bases 140 are extended towards a first direction and a second direction, and the first direction and the second direction are perpendicular to the rod 120, and the first direction and the second direction are opposite to each other.

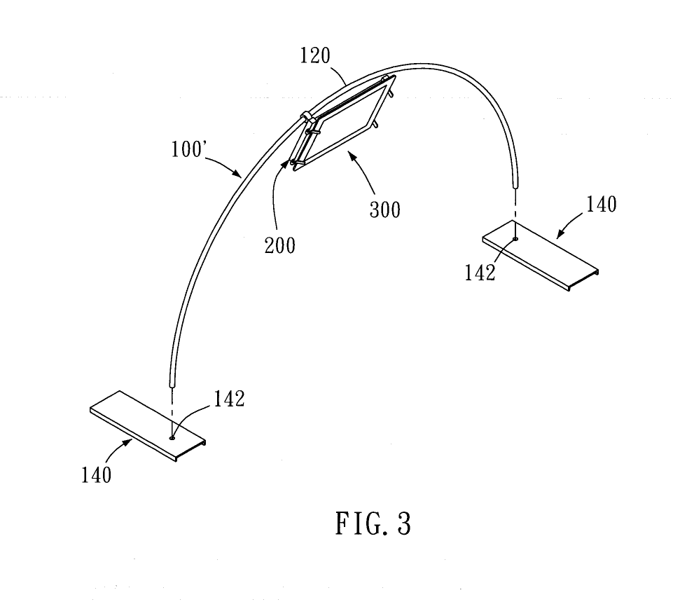

In this preferred embodiment, each of the bases 140 can be in the form of a rectangular plate. Of course, the bases 140 are not limited to this shape only, but they also can be circular plates or square plates as needed.

Wherein, the rod 120 and the bases 140 are coupled by a direct fixing method or an assembling method. More specifically, the rod 120 is fixed to the bases 140 directly by soldering or adhesion in the direct fixing method without requiring any installation by users, so that the electronic device support 100 can be used directly. In the assembling method, the connecting portion 142 comes with a notch (as shown in FIG. 3), and both ends of the rod 120 are snapped into the notches by a snapping or a compressing method, and thus the users can detach the rod 120 from the bases 140 for a convenient storage.

Wherein, the cross-sectional shape of the rod is a geometric shape such as a circular shape, an elliptical shape, a rectangular shape or a triangular shape, and the invention is not limited to the shape as shown in this preferred embodiment and related drawings, and the notch is in a shape corresponding to the cross-sectional shape of the rod.

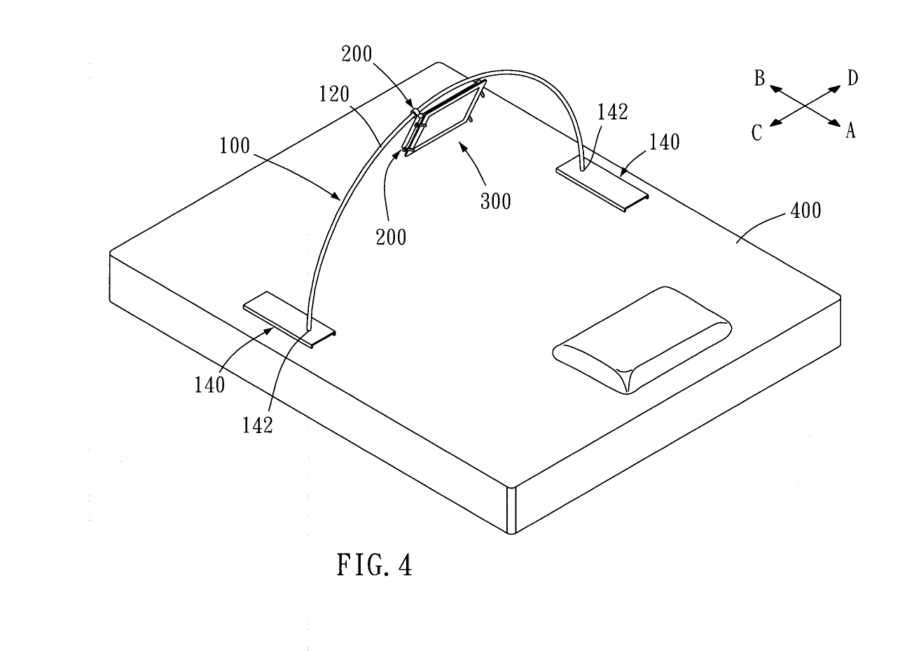

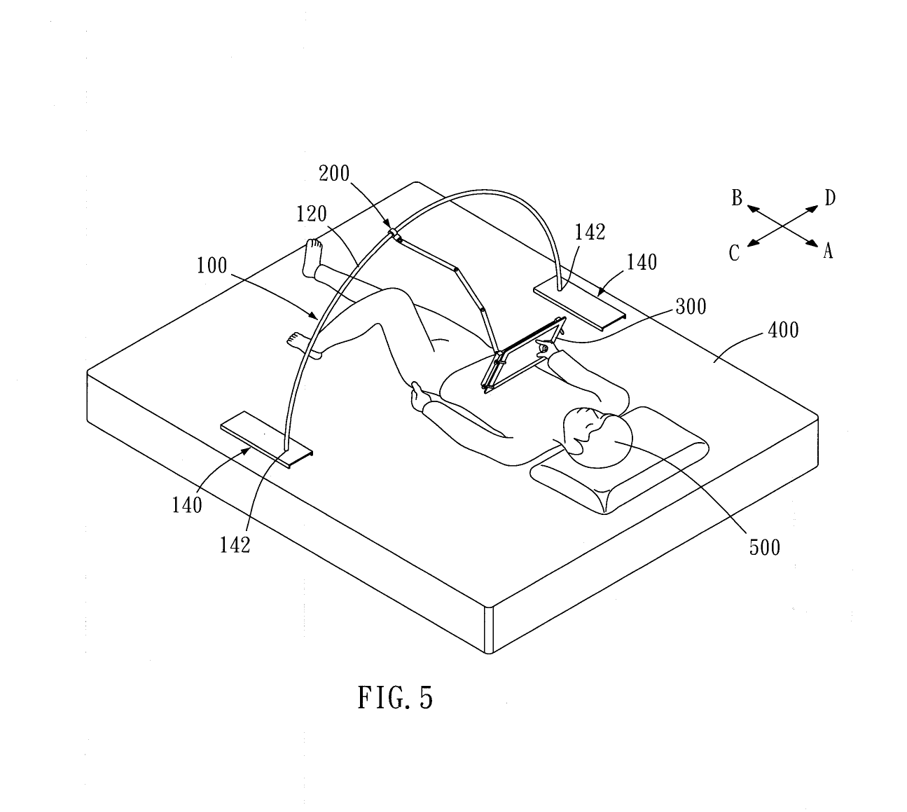

With reference to FIGS. 4 to 6 for schematic views of the using statuses of an electronic device support in accordance with a preferred embodiment of the present invention respectively, the electronic device support 100 can be stably set on a bed 400 through the bases 140. Since the rod 120 has an arc-shaped design, therefore the center of the rod 120 is far from the surface of the bed 400. In other words, when a user 500 lies on the bed 400, the bases 140 are situated on both sides of the user respectively, and the center of the rod 120 is situated above the body of the user 500.

Wherein, each of the connecting portions 142 is disposed near a peripheral edge of each of the bases 140. More specifically, in this preferred embodiment as shown in FIGS. 4 and 5, each of the connecting portions 142 is disposed proximate to an edge of the rectangular plate of each base 140, and the bases 140 are extended towards a first direction (which is the direction A as shown in the figures) and a second direction (which is the direction B as shown in the figures), and both directions A and B are perpendicular to the rod 120, and the directions A and B are opposite to each other, wherein the direction A is a direction towards the front end of the bed, and the direction B is a direction towards the rear end of the bed. Therefore, the electronic device support 100 allows the user 500 to leave the bed 400 from a side of the base 140 in a direction from the extending direction towards the rear end of the bed. In this preferred embodiment, the extending direction of the base 140 on the left side of the user 500 lying on the bed 400 is towards the rear end of the bed, so that the user 500 can leave the bed 400 from the left side (which is in the direction C as shown in the figures) and from the space between the bases 140 and the front end of the bed, so as to avoid hitting the electronic device support 100 and achieve the effect of leaving the bed 400.

If the rod 120 and the bases 140 are coupled by the assembling method, the user can adjust the extending direction of each of the bases 140 according to the user's habit and preference. For example, if the user 500 lying in the bed 400 has the habit of leaving the bed 400 in the direction D, then the extending direction of the bases 140 can be adjusted in the direction opposite to that as shown in the figures.

In FIG. 5, the rod 120 can raise the electronic device 300 clamped by the clamping means 200 for the purpose of viewing and operating the electronic device by the user 500, and the clamping means 200 includes a contractible and foldable support and a universal joint, so that the user 500 can pull or push the support to adjust the installation position and the angle of the electronic device 300 in order to use the electronic device 300 conveniently or fold the clamping means 200 when the electronic device 300 is not in use.

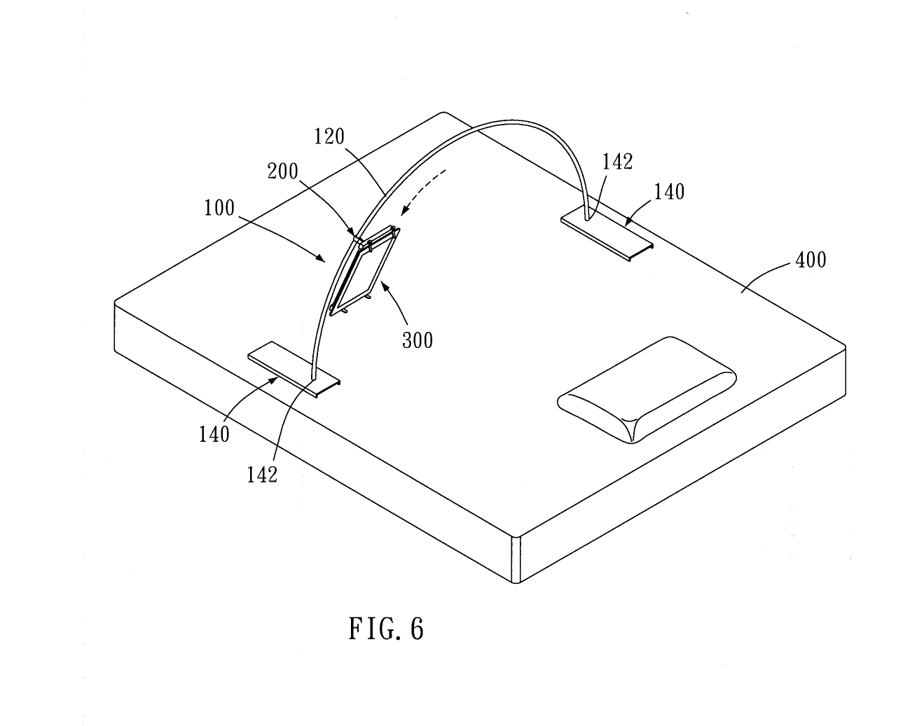

In FIG. 6, the rod 120 is designed with an arc shape to allow the users to freely adjust the position of the clamping means 200 in order to adjust the position of the electronic device 300. In other words, the clamping means 200 can be adjusted to move along the rod 120 by the users, so that the electronic device 300 is shifted to one of the ends of the rod 120. For example, if the user wants to lie on a side, the electronic device 300 can be adjusted to an appropriate position faced by the user, so that the user lying on a side still can view and operate the electronic device 300 conveniently. Wherein, the curvature of the rod 120 can be smaller than, equal to or greater than 180 degrees. In this preferred embodiment, the curvature of the rod 120 is equal to 180 degrees.

In summation of the description above, the electronic device support of the present invention adopts the combination of the arc shaped rod and the bases to raise and fix the electronic device appropriately by the electronic device support, so as to achieve the effects of facilitating a user who lies in bed to use the electronic device without holding the electronic device as well as facilitating the user to leave the bed.

While the invention has been described by means of specific embodiments, numerous modifications and variations could be made thereto by those skilled in the art without departing from the scope and spirit of the invention set forth in the claims.

What is claimed is:

1. An electronic device support, provided for installing a clamping means that clamps and holds an electronic device, comprising:
a rod, substantially in an arc shape; and
two bases, each having a connecting portion, and both ends of the rod being installed at the connecting portions respectively;
wherein, each connecting portion is situated near a peripheral edge of each base, and the bases are extended towards a first direction and a second direction respectively, and the first direction and the second direction are perpendicular to the rod, and the first direction and the second direction are opposite to each other.

2. The electronic device support of claim 1, wherein the rod is coupled to the bases by an assembling method or a direct fixing method.

3. The electronic device support of claim 2, wherein each of the connecting portions has a notch, and both ends of the rod are latched into the notches respectively.

4. The electronic device support of claim 1, wherein the rod has a curvature equal to 180 degrees.

5. The electronic device support of claim 2, wherein the rod has a curvature equal to 180 degrees.

6. The electronic device support of claim 3, wherein the rod has a curvature equal to 180 degrees.

7. The electronic device support of claim 1, wherein the rod has a cross-sectional shape which is a geometric shape selected from the group of a circular shape, an elliptical shape, a rectangular shape and a triangular shape.

8. The electronic device support of claim 2, wherein the rod has a cross-sectional shape which is a geometric shape selected from the group of a circular shape, an elliptical shape, a rectangular shape and a triangular shape.

9. The electronic device support of claim 3, wherein the rod has a cross-sectional shape which is a geometric shape selected from the group of a circular shape, an elliptical shape, a rectangular shape and a triangular shape.

10. The electronic device support of claim 4, wherein the rod has a cross-sectional shape which is a geometric shape selected from the group of a circular shape, an elliptical shape, a rectangular shape and a triangular shape.

11. The electronic device support of claim 5, wherein the rod has a cross-sectional shape which is a geometric shape selected from the group of a circular shape, an elliptical shape, a rectangular shape and a triangular shape.

12. The electronic device support of claim 6, wherein the rod has a cross-sectional shape which is a geometric shape selected from the group of a circular shape, an elliptical shape, a rectangular shape and a triangular shape.
